(19) United States
(12) Patent Application Publication
(10) Pub. No.: US 2025/0148079 A1
(43) Pub. Date: May 8, 2025

(54) MOBILE SECURITY FILE LEAKAGE DETECTION METHOD AND SYSTEM

(71) Applicant: UROCK Inc., Seongnam-si (KR)

(72) Inventors: Hong Sun LEE, Chuncheon-si (KR); Jang Hoon KIM, Suwon-si (KR); Jae Hwan LEE, Seongnam-si (KR); Sung Woo AN, Seongnam-si (KR); Bong Seok YOU, Uiwang-si (KR); Jeong Min HONG, Seoul (KR); Seon Ho HWANG, Seoul (KR); Jae Wook JEONG, Seongnam-si (KR)

(21) Appl. No.: 18/948,632

(22) Filed: Nov. 15, 2024

Related U.S. Application Data
(63) Continuation-in-part of application No. PCT/KR2024/013299, filed on Sep. 4, 2024.

(30) Foreign Application Priority Data
Nov. 2, 2023 (KR) 10-2023-0149657

(51) Int. Cl. G06F 21/55

(52) U.S. Cl. CPC G06F 21/554

(57) ABSTRACT

A method of detecting mobile security file leakage of the present disclosure includes receiving, by a detection server, an operating system type from a mobile device, connecting, by the detection server, to the mobile device depending on an operating system to load a media file system, checking an analysis setting time by the detection server connected to the mobile device, analyzing, by the detection server, the media file system to detect presence or absence of an abnormality, generating, by the detection server, an analysis result based on presence or absence of an abnormality, checking whether there is an error in the analysis result and extracting an original file and a thumbnail file if there is no error by the detection server, deleting, by the detection server, a file from which an abnormality is detected based on the analysis result, and generating and storing a result report on the analysis result by the detection server, wherein the operating system type is at least one of a first operating system and a second operating system.

### TECHNICAL FIELD

The present disclosure relates to a mobile security file leakage detection method and system, which can detect abnormal media files after connecting a mobile device to a PC to collect data, extract the files from the mobile device, delete or save the files, and generate a result report.

### BACKGROUND ART

Mobile security is one of the key elements of mobile devices, which provides a better security function for smartphones, laptops, and tablets. Recently, companies and enterprises are increasingly using BYOD (Bring Your Own Device) to create efficient workspaces for employees. Therefore, employees can use company networks not only during working hours but also when they are outside the company premises, and thus the need to ensure the safety and security of financial and corporate data from remote locations is increasing. In addition, since important business data is accessed through mobile devices, mobile devices need to be managed and secured within each corporate environment.

Mobile device management (MDM) refers to a set of tools that provide employees with mobile productivity tools and applications while maintaining the security of enterprise data to overcome the above-described problems. However, disadvantages such as infringement of personal information, excessive information collection, and complexity compared to efficiency are being discovered as MDM is used. In order to prevent personal information infringement of MDM, it is necessary to set a scope, perform selection and analysis based on a specific point in time, and prevent advance leakage through a media file deletion function.

As for prior patents, there is Korean Patent No. 10-1501669 (Action detection system for detecting abnormal action), but it only provides an action detection system for detecting an abnormal action which can implement dynamic control based on user-specific situation information and profiles to respond to factors that threaten the security of internal corporate infrastructure, such as information leakage in BYOD (Bring Your Own Device) and smart work environments.

### SUMMARY

### Technical Problems

An object of the present disclosure devised to solve the problems of the prior art as mentioned above is to set a range based on a specific point in time through an automated system and analyze abnormal files in order prevent infringement of personal information and privacy, thereby improving the speed of mobile device detection and analysis, preventing excessive access to and response to stored information, and preventing advance leakage through a media file deletion function.

### Technical Solution

A method of detecting mobile security file leakage of the present disclosure includes receiving, by a detection server, an operating system type from a mobile device, connecting, by the detection server, to the mobile device depending on an operating system to load a media file system, checking an analysis setting time by the detection server connected to the mobile device, analyzing, by the detection server, the media file system to detect presence or absence of an abnormality, generating, by the detection server, an analysis result based on presence or absence of an abnormality, checking whether there is an error in the analysis result and extracting an original file and a thumbnail file if there is no error by the detection server, deleting, by the detection server, a file from which an abnormality is detected based on the analysis result, and generating and storing a result report on the analysis result by the detection server, wherein the operating system type is at least one of a first operating system and a second operating system.

A mobile security file leakage detection system of the present disclosure includes a mobile device configured to transmits an operating system type to a detection server and connected to the detection server depending on the operating system type, and the detection server configured to receive the operating system type from the mobile device, connect to the mobile device depending on an operating system to load a media file system, check an analysis setting time, analyze the media file system to detect presence or absence of an abnormality, generate an analysis result based on presence or absence of an abnormality, check whether there is an error in the analysis result, extract an original image and a thumbnail image if there is no error, delete a file from which an abnormality is detected based on the analysis result, and generate and store a result report on the analysis result.

### Effect of Invention

According to one embodiment of the present disclosure, it is possible to connect a mobile device to a PC for each operating system and detect abnormal media files in order to complement the limitations of the MDM solution, and a standardized communication protocol can be used to flexibly respond to updates of each operating system and compatibility with new devices.

In addition, abnormal files can be extracted from a mobile device and stored on a PC, and a result report with respect to the same can be generated.

In addition, a result report and mobile device analysis content and statistics can be checked remotely through a web manager.

### BRIEF DESCRIPTION OF THE DRAWING

FIG. 1 is a flowchart illustrating a mobile security file leakage detection method according to an embodiment of the present disclosure.

FIG. 2 is a flowchart illustrating a method of analyzing a media file system of a mobile device whose operating system type is a first operating system to detect whether there is an abnormality according to an embodiment of the present disclosure.

FIG. 3 is a flowchart illustrating a method of analyzing a media file system of a mobile device whose operating system type is a second operating system to detect whether there is an abnormality according to an embodiment of the present disclosure.

FIG. 4 is a configuration diagram illustrating a mobile security file leakage detection system according to an embodiment of the present disclosure.

FIG. 5A shows a screen by which mobile device analysis content and statistics can be remotely checked through a web manager according to an embodiment of the present disclosure.

FIG. 5B shows a screen by which mobile device analysis content and statistics can be remotely checked through a web manager according to an embodiment of the present disclosure.

FIG. 6 shows a screen show screens by which mobile device analysis content and statistics can be remotely checked through a web manager according to an embodiment of the present disclosure.

### DETAILED DESCRIPTION OF EXEMPLARY EMBODIMENTS

The description of the present disclosure is only an example for structural or functional explanation, and the scope of the present disclosure should not be construed as limited by the embodiments described herein. In other words, the embodiments can be modified in various ways and can have various forms, and the scope of the present disclosure should be understood to include equivalents that can realize the technical idea.

Since the embodiments according to the concept of the present disclosure may have various changes and may have various forms, the embodiments are illustrated in the drawings and described in detail in this specification. However, this is not intended to limit the embodiments according to the concept of the present disclosure to specific disclosed forms, but includes all modifications, equivalents, or substitutes included in the spirit and technical scope of the present disclosure.

The terms used in this specification are only used to describe specific embodiments, and are not intended to limit the present disclosure. Singular expressions should be understood to include plural expressions unless the context clearly indicates otherwise, and terms such as “comprise or include” or “have” are intended to specify the existence of implemented features, numbers, steps, operations, components, parts, or combinations thereof, but should be understood as not precluding the possibility of the existence or addition of one or more other features, numbers, steps, operations, components, parts, or combinations thereof.

Hereinafter, embodiments of the present disclosure will be described in detail with reference to the drawings attached to this specification.

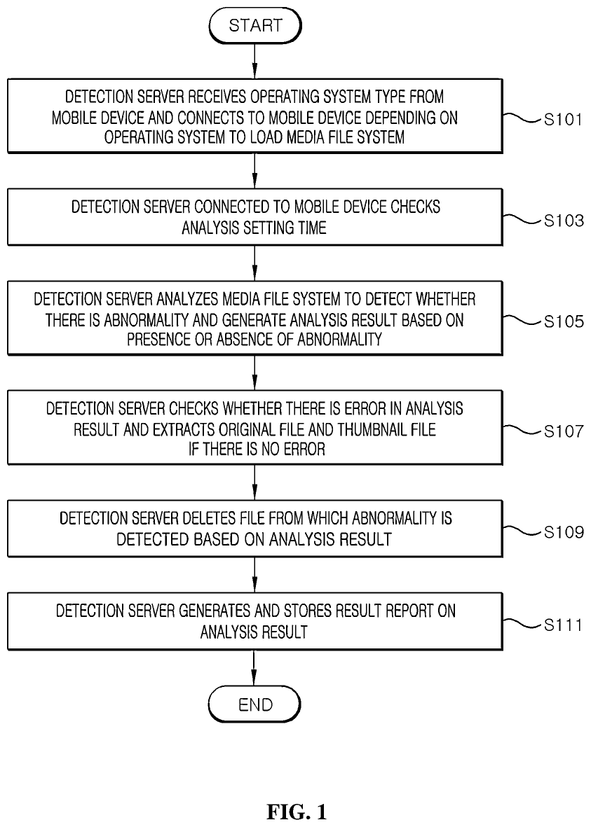

FIG. 1 is a flowchart illustrating a mobile security file leakage detection method according to an embodiment of the present disclosure.

Referring to FIG. 1, a detection server 200 may receive an operating system type from a mobile device 100, and connect to the mobile device 100 depending on the operating system type to load a media file system (S101). The mobile device 100 may include a mobile device such as a smartphone, a mobile phone, a computer, a laptop, a digital broadcasting terminal, a personal digital assistant (PDA), a portable multimedia player (PMP), or a tablet, but the present disclosure is not necessarily limited thereto and the mobile device 100 may be various devices equipped with a display screen, such as a laptop, a PDA, and a wearable device (watch, glasses, etc.) in addition to a tablet device and a smartphone. The operating system type may be at least one of a first operating system and a second operating system, the first operating system may be an Android operating system, and the second operating system may be an iOS operating system, but the present disclosure is not necessarily limited thereto.

When the operating system received from the mobile device 100 is the first operating system, the detection server 200 may load a media file system from the mobile device 100 through media transfer protocol (MTP) communication and connect to the mobile device 100 through a command using the Android Debug Bridge (ADB) debugging tool.

The detection server 200 may connect to the mobile device 100 through MTP communication when the operating system received from the mobile device 100 is the second operating system. In addition, the detection server 200 may connect to the mobile device 100 using Apple File Conduit (APC) to improve the connection speed and access media files of a wide area.

The detection server 200 connected to the mobile device 100 checks an analysis setting time (S103). The analysis setting time may refer to a time set before the start of analysis, and analysis can be performed only for the period corresponding to the analysis setting time in the media file system loaded from the mobile device 100. The detection server 200 analyzes the media file system to detect whether there is an abnormality, and generates an analysis result based on whether there is an abnormality (S105). Here, the detection server 200 may check a log regarding use of a camera and determine that an abnormality has occurred if use of the camera is detected during the analysis setting time. In addition, the detection server 200 may check whether directory and file creation times and modification times of the mobile device 100 fall within the analysis setting time, and determine that an abnormality has occurred if creation and modification of a directory and a file are detected during the analysis setting time. In addition, the detection server 200 may check a log related to media, analyze a usage pattern, and determine that an abnormality has occurred if a media file creation and action different from the pattern are detected. In addition, the detection server 200 may check DB data related to media, extract necessary data, and determine whether there is an abnormality.

The detection server 200 checks whether there is an error in the analysis result, and if there is no error, extracts an original file and a thumbnail file (S107). The original file may be used for storage purposes, and the thumbnail file may be used for additional purposes when a result report is generated. The detection server 200 deletes a file for which an abnormality has been detected on the basis of the analysis result (S109), and the detection server 200 creates and stores a result report on the analysis result (S111). The detection server 200 may generate a file list of files that have information on leakage or are in violation of security based on the analysis result, and delete the files from the mobile device 100. When the detection server 200 deletes a file, the detection server 200 may select a location at which the file is to be deleted in the local PC and the mobile device 100 and delete the file, and a deletion reason may be written for deletion management. The aforementioned result report may include at least one of, but is not necessarily limited to, analyzed mobile device information, analyst information, analysis result information, a file list including thumbnails, a list of deleted files, camera usage information, and timeline summary information.

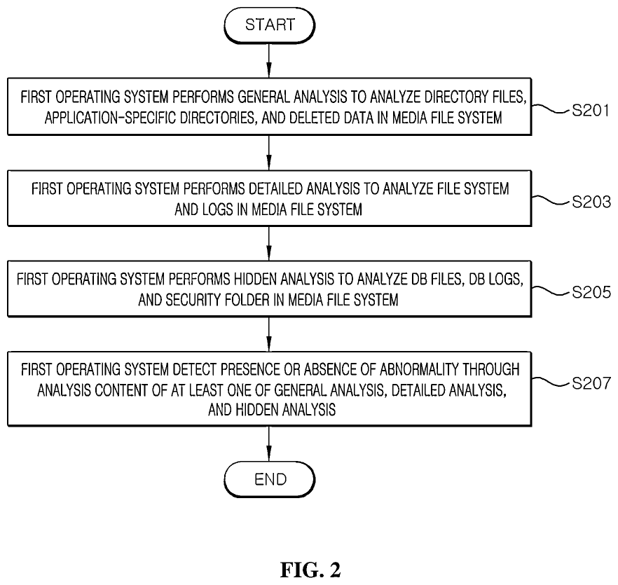

FIG. 2 is a flowchart illustrating a method of analyzing a media file system of a mobile device whose operating system type is the first operating system to detect whether there is an abnormality according to an embodiment of the present disclosure.

Referring to FIG. 2, the first operating system 220 performs general analysis of analyzing a directory file, an application-specific directory, and deleted data in the media file system (S201). According to the general analysis, the file system of the mobile device can be loaded through MTP communication, and directory file analysis, application-specific directory analysis, and deleted data analysis can be performed. The first operating system 220 performs detailed analysis of analyzing a file system and log in the media file system (S203). The detailed analysis may be performed through an ADB debugging tool, and file system analysis and log analysis can be performed through the detailed analysis. The first operating system 220 performs hidden analysis of analyzing a DB file, a DB log, and a security folder in the media file system (S205). Samsung Galaxy mobile devices using the Android operating system provide a secure folder function, and thus when the secure folder function is used to utilize a camera, a shooting history can only be accessed with administrator rights and cannot be checked because it is encrypted. Therefore, the first operating system 220 can perform separate hidden analysis on Samsung Galaxy mobile devices. The first operating system 220 detects whether there is an abnormality using analysis content of at least one of the general analysis, detailed analysis, and hidden analysis (S207).

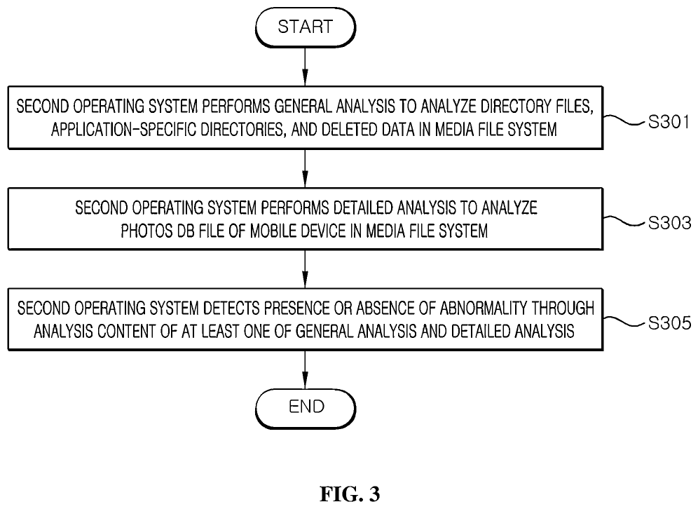

FIG. 3 is a flowchart illustrating a method of analyzing a media file system of a mobile device whose operating system type is the second operating system to detect whether there is an abnormality according to an embodiment of the present disclosure.

Referring to FIG. 3, the second operating system 230 performs general analysis of analyzing a directory file, an application-specific directory, and deleted data in the media file system (S301). According to the general analysis, a list of media-related files and a directory list of the mobile device 100 can be obtained by utilizing AFC, and directory file analysis, application-specific directory analysis, and deleted data analysis can be performed. The second operating system 230 analyzes a media resource-related file of the mobile device in the media file system and performs detailed analysis (S303). The detailed analysis may be performed by analyzing a media resource-related file of an iOS mobile device. The second operating system 230 detects whether there is an abnormality using analysis content of at least one of the general analysis and the detailed analysis (S305).

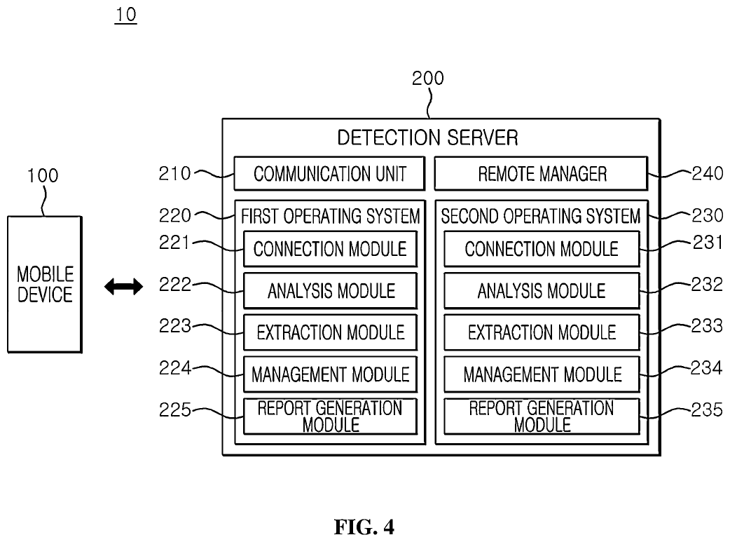

FIG. 4 is a configuration diagram illustrating a mobile security file leakage detection system according to an embodiment of the present disclosure.

Referring to FIG. 4, the mobile security file leakage detection system 10 includes a mobile device 100 and a detection server 200.

The mobile device 100 transmits an operating system type to the detection server 200 and may be connected to the detection server 200 through different methods depending operating system types. In addition, the mobile device 100 may receive information on confirmation of whether to consent to analysis from the detection server 200 and transmit an opinion on the consent to analysis to the detection server 200.

The mobile device 100 may include, but is not necessarily limited to, mobile devices such as smartphones, mobile phones, computers, laptops, digital broadcasting terminals, PDAs, PMPs, and tablets, and the mobile device 100 may correspond to various devices equipped with display screens, such as laptops, PDAs, wearable devices (watches, glasses, etc.), in addition to tablet devices and smartphones.

The detection server 200 includes a communication unit 210, a first operating system 220, a second operating system 230, and a remote manager 240.

The communication unit 210 may receive an operating system type from the mobile device 100. The operating system type may be at least one of the first operating system and the second operating system, the first operating system may be the Android operating system, and the second operating system may be the iOS operating system, but is not necessarily limited thereto. Additionally, the communication unit 210 may check whether the Internet network is properly connected and whether the mobile device 100 consents to analysis.

The first operating system 220 includes a connection module 221, an analysis module 222, an extraction module 223, a management module 224, and a report generation module 225.

The connection module 221 may load a media file system by connecting to the mobile device 100 depending on the operating system received from the mobile device 100 through the communication unit 210 and may obtain device information such as a serial number, firmware, and a device name. The connection module 221 may output the device information on the screen and store the same to perform device management. The connection module 221 may check whether there is an Internal storage subdirectory or file in order to check connection to the mobile device 100, load the total disk capacity and available capacity of the mobile device, and calculate the disk capacity being used.

The connection module 221 may load the media file system from the mobile device 100 through media transfer protocol (MTP) communication when the operating system received from the mobile device 100 through the communication unit 210 is the first operating system. When the user of the mobile device 100 allows an MTP connection, the connection module 221 can read the media file system, and the connection between the detection server 200 and the mobile device 100 can be completed. Since the connection module 221 can read the media file system, the connection module 221 can check directories and files under the Internal Storage directory, and accordingly, connect to the device 100 to become a state in which it can perform general analysis. When the connection module 221 connects to the mobile device 100 through MTP communication, it is possible to provide a convenient and easy-to-use interface to general users, and the connection can be conveniently performed since the connection operation is not difficult.

The connection module 221 may have a different connection method depending on the analysis method when the operating system received from the mobile device 100 through the communication unit 210 is the first operating system. An MTP connection checking operation may be performed in the case of general analysis and a connection checking operation using ADB communication may be performed in the case of detailed analysis, but the present disclosure is not necessarily limited thereto. The connection module 221 may connect to the mobile device 100 through a command using an Android Debug Bridge (ADB) debugging tool. When the user turns on a developer mode option and allows a debugging mode on the mobile device 100, the connection module 221 may complete connection between the detection server 200 and the mobile device 100 using the ADB debugging tool. When the connection module 221 connects to the mobile device 100 using the ADB debugging tool, the connection operation may take a long time depending on the user's skill level and situation because the connection operation involves steps of inputting various menus and a user interface needs to be input.

The analysis module 222 may set information of the connected mobile device 100 and an analysis setting time when the connection module 221 completes the connection with the mobile device 100. The analysis setting time may refer to a time set before the start of analysis, and analysis can be performed only for the period corresponding to the analysis setting time in the media file system loaded from the mobile device 100. In addition, the analysis module 222 may analyze the media file system to detect whether there is an abnormality during the analysis setting time, and may detect whether there is an abnormality through analysis content of at least one of general analysis, detailed analysis, and hidden analysis. The analysis module 222 may generate an analysis result based on the detected abnormality. Here, the analysis module 222 may check the log regarding the use of the camera and determine that an abnormality has occurred if the use of the camera is discovered during the analysis setting time. In addition, the analysis module 222 may check whether creation times and modification times of directories and files of the mobile device 100 fall within the analysis setting time, and if creation and modification of a directory and a file are discovered during the analysis setting time, may determine the same as an abnormality. Further, the analysis module 222 may check the log regarding media, analyze a usage pattern, and if media file generation and action different from the pattern are discovered, determine the same as an abnormality. In addition, the analysis module 222 may check DB data related to media, extract necessary data, and determine whether there is an abnormality.

The analysis module 222 may perform general analysis when the operating system received from the mobile device 100 through the communication unit 210 is the first operating system. According to the general analysis, the file system of the mobile device can be loaded through MTP communication, and directory file analysis, application-specific directory analysis, and deleted data analysis can be performed. First, the analysis module 222 may detect a directory required for analysis and analyze subdirectories and files for directory file analysis. If a directory modification time does not fall within the analysis setting time, subfiles are not analyzed and only the subdirectories are analyzed, which can improve the speed compared to a case in which all files are analyzed. If the modification times of all directories do not fall within the analysis setting time, analysis can be rapidly completed as “no abnormality”. If a file is found during the search process, the file can be detected as an abnormal file. If no file is found but only a folder is found, this can be reflected in the analysis result according to information of the found directory. Secondly, the analysis module 222 may perform application-specific directory analysis. Basically, media files created using a camera are generated under the Camera directory. Third-party camera applications installed from the App Store also create directories and save files under the Camera directory or the Pictures directory. In the case of audio files, they are also saved under different directories depending on the mobile device model and OS version, such as Voice Recorder, Sounds, Recordings, my_sounds, and AudioRecorder. The analysis module 222 may check a package directory of an application installed by the user in the directory of the system area in the directory list of the mobile device 100 and find media files captured or created in a subdirectory. The analysis module 222 may also detect and extract media files (thumbnails, cache, and the like) deleted from an application's chat room and files created by an application and deleted from a gallery depending on applications. Thirdly, the analysis module 222 may perform deletion data analysis. When a file is deleted and moved to the trash, the modification time of the parent directory of the file changes. In addition, when a file in the trash is deleted, the modification time of the trash directory changes. If a file is not found but the directory modification time of the trash has changed, the analysis module 222 may reflect this deletion and modification action as an “abnormality”.

The analysis module 222 may perform detailed analysis when the operating system received from the mobile device 100 through the communication unit 210 is the first operating system. The detailed analysis may be performed through the ADB debugging tool, and file system analysis and log analysis can be performed according to the detailed analysis. First, the analysis module 222 may perform file system analysis. Since the ADB debugging tool enables more authority and a higher level of control, the analysis module 222 can check an area other than the file system loaded through MTP communication. Since the directory and file access speed through commands is high, the file system analysis speed is improved, and the analysis module 222 can detect directories and files with high access authority or hidden directories and files. In an embodiment, the trash area cannot be detected in MTP communication in Android 11 or lower, but the trash area can be detected through the ADB debugging tool. Secondly, the analysis module 222 may extract various service logs recorded when media files are created, modified, deleted, or loaded or a media-related service is called through a command providing information on a system service in the ADB debugging tool. The various service logs may be at least one of a log for collecting information on an application usage pattern of a user, an audio service-related system log, a vibration-related log of the mobile device 100, a log for recording statistics and information on media sessions, and a status information log related to a system camera service, but the present disclosure is not necessarily limited thereto.

The analysis module 222 may analyze the log file to check traces of executing cameras in the basic camera, 3rd party application, and SNS application and logs of shooting and transmitting media files.

The log for collecting information on an application usage pattern of a user can record actions with respect to using a single application over a specific time range, such as taking pictures and videos or creating recording files with at least one of a basic camera application and a messenger application. The messenger application may be at least one of KakaoTalk, WhatsApp, Line, Telegram, Instagram, and WeChat, and may include all digital platforms through which messages can be sent and received via messenger.

The audio service-related system log can record log data along with time information when audio output occurs according to actions at the time of taking pictures and videos or creating recording files with at least one of the basic camera application and the messenger application.

The vibration-related log of the mobile device 100 can record data logs on vibration occurrence at the time of taking pictures and videos or creating recording files with at least one of the basic camera application and the messenger application. Based on the data logs, an action of taking at least one of a pictures and a video can be found.

The log for recording statistics and information on media sessions can collect and record detailed information on media playback, whether a codec is used, and audio/video processing. At the time of taking pictures and videos with at least one of the basic camera application and the messenger application, generated media information and system resource usage information can be recorded in a log file.

The status information log regarding the system camera service can record log when a camera device is called with at least one of the basic camera application and the messenger application. Through the recorded log, the currently active camera session, request information, and camera status information can be checked.

The analysis module 222 may generate timeline data based on a log with respect to execution and calling of a camera. The analysis module 222 may more accurately identify actions for creating media files by combining media files, camera shooting logs, and transmission logs present in the mobile device 100 on the basis of the timeline. In addition, the analysis module 222 may determine that a deletion action has been performed if a shooting log exists but any file does not exist. The analysis module 222 can perform more detailed analysis by performing detailed analysis for analyzing the file system and logs in the media file system at a higher data transfer rate than general analysis and executing complex commands.

The analysis module 222 may perform hidden analysis when the operating system received from the mobile device 100 through the communication unit 210 is the first operating system. Since Samsung Galaxy mobile devices using the Android operating system provide a secure folder function, if the camera is used by utilizing the secure folder function, the shooting history is restricted and encrypted and thus cannot be confirmed. Therefore, the analysis module 222 may perform analysis through separate hidden analysis for Samsung Galaxy mobile devices. The analysis module 222 may extract captured media resource-related files using a media file dump function through a hidden menu and perform DB file analysis, DB log analysis, and security folder analysis. First, the analysis module 222 may check not only a list of media resource-related files but also metadata such as shared IDs, longitude, and latitude for DB file analysis. Secondly, the analysis module 222 may extract media database-related files and check DML-related logs added to a media DB for DB log analysis. The analysis module 222 may check query logs related to INSERT, UPDATE, and DELETE and analyze the actions. Thirdly, the analysis module 222 may detect a security folder. Since the security folder provided by Samsung cannot be accessed with general user rights, the analysis module 222 may extract a list of media files created or located using the security folder application.

The extraction module 223 may determine whether there is an error in the analysis result generated by the analysis module 222, and if there is no error, extract the analysis result. The extraction module 223 may extract at least one of an original file and a thumbnail file. The original file is used for storage purposes, and the thumbnail file is used for an additional purpose when a result report is generated.

In order for the extraction module 223 to extract the original file, the extraction module 223 uses a media device communication library to copy the file in the case of MTP communication. When ADB is used, the extraction module 223 uses a command to copy the file in the device to a PC to copy the file. The access speed is higher when ADB is used than when MTP communication is used. When the extraction module 223 extracts the original file, it also includes MD5 and SHA256 hash values to verify the integrity of the original file.

In order for the extraction module 223 to extract the thumbnail file, the extraction module 223 uses the media device communication library to extract the thumbnail file that can be loaded in the case of MTP. In the case of ADB, the extraction module 223 generates a thumbnail using a library that generates an image by utilizing an original image if the thumbnail file cannot be extracted.

The management module 224 may delete a file detected to be abnormal according to the analysis result generated by the analysis module 222. The management module 224 may create a file list of files that have leaked information or are in violation of security on the basis of the analysis results and delete the files from the mobile device 100. When the management module 224 deletes a file, the management module 224 may select a location at which the file is to be deleted in the local PC and the mobile device 100 from which the file has been extracted, and a deletion reason may be written for deletion management.

The report generation module 225 may generate a result report based on the analysis result generated by the analysis module 222 and deletion information from the management module 224 when deletion is completed in the management module 224. The result report may include at least one of analyzed mobile device information, analyst information, analysis result information, a file list including thumbnails, a deleted file list, camera usage information, and timeline summary information, but the present disclosure is not necessarily limited thereto. The result report generated by the report generation module 225 may be extracted as a PDF file.

The second operating system 230 includes a connection module 231, an analysis module 232, an extraction module 233, a management module 234, and a report generation module 235.

The connection module 231 may load the media file system by connecting to the mobile device 100 according to the operating system received from the mobile device 100 through the communication unit 210. The connection module 231 may connect to the mobile device 100 through MTP communication when the operating system received from the mobile device 100 through the communication unit 210 is the second operating system. In addition, the connection module 231 may connect to the mobile device 100 using Apple File Conduit (AFC) to improve the connection speed and access media files of a wide area. The connection module 231 may check whether the mobile device 100 is connected to the detection server 200 using liDeviceLib. If connected, it can have a unique identification value, which is a udid value. In order for the connection module 231 to load a directory and files of the mobile device 100 using AFC, trust permission of the mobile device 100 is required. The connection module 231 checks whether the mobile device 100 is in a permission state using a library that checks and controls lock settings and activation information of the mobile device 100 and a library responsible for controlling the mobile device, and if the mobile device 100 is in the permission state, completes the connection.

The analysis module 232 may check an analysis setting time when the connection module 231 completes the connection to the mobile device 100. The analysis setting time may refer to a time set before the start of analysis, and analysis can be performed only for the period corresponding to the analysis setting time in the media file system loaded from the mobile device 100. In addition, the analysis module 232 may analyze the media file system to detect whether there is an abnormality during the analysis setting time, and may detect whether there is an abnormality through analysis content of at least one of general analysis and detailed analysis. The analysis module 232 may generate an analysis result based on a detected abnormality. Here, the analysis module 232 may check the log regarding the use of the camera and determine that an abnormality has occurred if the use of the camera is discovered during the analysis setting time. In addition, the analysis module 232 may check whether creation times and modification times of directories and files of the mobile device 100 fall within the analysis setting time, and if creation and modification of a directory and a file are discovered during the analysis setting time, determine the same as an abnormality. Further, the analysis module 232 may check the log regarding media, analyze a usage pattern, and if media file generation and action different from the pattern are discovered, determine the same as an abnormality. In addition, the analysis module 232 may check DB data related to media, extract necessary data, and determine whether there is an abnormality.

The analysis module 232 may perform general analysis when the operating system received from the mobile device 100 through the communication unit 210 is the second operating system. According to the general analysis, a list of media-related files and directories of the mobile device 100 can be obtained by utilizing AFC, and directory file analysis, application-specific directory analysis, and deleted data analysis can be performed. First, the analysis module 232 may select a directory required for analysis in order to analyze a directory file and analyze subdirectories and subfiles. If the modification time of the directory does not fall within the analysis setting time, the subfiles are not analyzed and only the information on the directory is analyzed, which can improve the speed compared to a case in which all files are analyzed. If the modification times of all directories do not fall within the analysis setting time, the analysis can be rapidly completed with “no abnormality”. In addition, the analysis module 232 may check a file including at least one of device information and media information prior to directory detection. If there is an abnormality, the analysis module 232 can operate like the analysis module 222, but if a photo has not been actually taken, the analysis module 232 can output a result of “no abnormality” within 2 seconds unlike the analysis module 222. If a file is found during a search process, the file can be detected as an abnormal file. If a file is not found but only a folder is found, it can be reflected in the analysis result according to the information of the found directory. Secondly, the analysis module 232 may perform directory analysis for each application. Photo and video files taken with an iOS mobile device are stored with a directory name and regular file names under a specific rule under the DCIM directory. In the case of audio files, they are stored under the Recordings directory, and actions of creating, changing, and deleting audio files by performing the directory analysis method as above in the Recordings directory are optionally set such that audio files can be analyzed through settings in an agent or a web manager. If audio file analysis is activated, designated directory detection and analysis are performed. Thirdly, the analysis module 232 may perform deleted data analysis. The analysis module 232 may check media files deleted and moved to the trash by the user through directory analysis. Since an image file has a file name with a specific rule, data deleted from the trash can be inferred based on the most recent file before the analysis setting time and the files currently existing in the mobile device. In addition to the DCIM directory where photos are stored, thumbnails or cache data of deleted files can exist in directories where media files and setting files are stored. The analysis module 232 may extract the files and check temporary files that are files deleted by the user but remain in the mobile device 100.

The analysis module 232 may perform detailed analysis when the operating system received from the mobile device 100 through the communication unit 210 is the second operating system. According to the detailed analysis, media resource related files of an iOS mobile device can be analyzed. Photos and videos related to iOS are managed in the photos.sqlite db file. The analysis module 232 may check a generated file list in a table for managing media file information, and extract files belonging to the analysis setting time from the file list to perform analysis. The file list may be checked in a table where transaction logs of one unit generated in relation to a DB are stored. The analysis module 232 may check deleted file information in a table in which information on changes in DB data is stored. The list of files uploaded to the cloud connected to the device is checked in the table for managing media file information linked to the cloud provided by the second operating system, and by joining such a table, data deleted from the trash can be checked using accurate data such as the creation time and deletion time of a deleted file, instead of being inferred using the most recent file before the analysis setting time, which is the content of the aforementioned general analysis, and the files currently existing in the mobile device. In addition, detailed analysis can have more accurate deleted file information than general analysis.

The extraction module 233 may determine whether there is an error in the analysis result generated by the analysis module 232, and if there is no error, extract the analysis result. The extraction module 233 may check whether there is an error in the analysis result based on the result of at least one exception processing among whether the mobile device 100 has been disconnected in the middle of operation, whether the file being analyzed is a normal file to be analyzed, and whether the analysis system has operated correctly, but the present disclosure is not necessarily limited thereto. The extraction module 233 may extract at least one of an original file and a thumbnail file. The original file may be used for storage purposes, and the thumbnail file may be used for additional purposes when a result report is generated.

The extraction module 233 uses AFC to open and copy a file from the mobile device 100 to extract the original file. When the extraction module 233 extracts the original file, it also includes MD5 and SHA256 hash values to verify the integrity of the original file.

To extract the thumbnail file, the extraction module 233 may use AFC to check whether a thumbnail in the thumbnail file list matches the original file, and if the original file exists but the thumbnail does not exist, generate a thumbnail based on the original file. If the thumbnail exists but the original file does not exist, this can be reflected in the result of presence or absence of an abnormality according to the directory and analysis content.

The management module 234 may delete a file that is detected to be abnormal based on the analysis result generated by the analysis module 232. The management module 234 may generate a list of files that have leaked information or are in violation of security based on the analysis result, and delete the files from the mobile device 100. When the management module 234 deletes a file, the management module 234 may select a location at which the file is to be deleted in the local PC and the mobile device 100 and delete the file, and a deletion reason may be written for deletion management.

When deletion is completed in the management module 234, the report generation module 235 may generate a result report based on the analysis result generated by the analysis module 232 and deletion information of the management module 234. The result report may include at least one of analyzed mobile device information, analyst information, analysis result information, a file list including thumbnails, a deleted file list, camera usage information, and timeline summary information, but the present disclosure is not necessarily limited thereto. The result report generated by the report generation module 235 may be extracted as a PDF file.

The remote manager 240 may create a page (web manager) through which the content stored in the communication unit 210, result reports generated from the first operating system 220 and the second operating system 230, and other stored content can be remotely checked through the web.

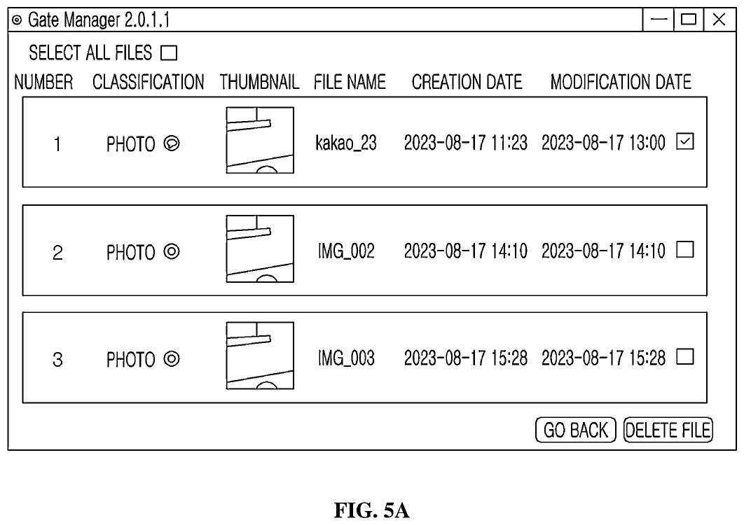

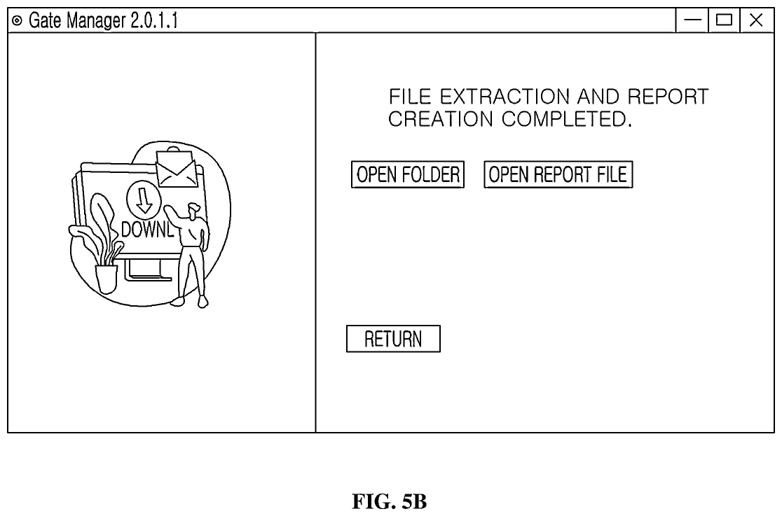

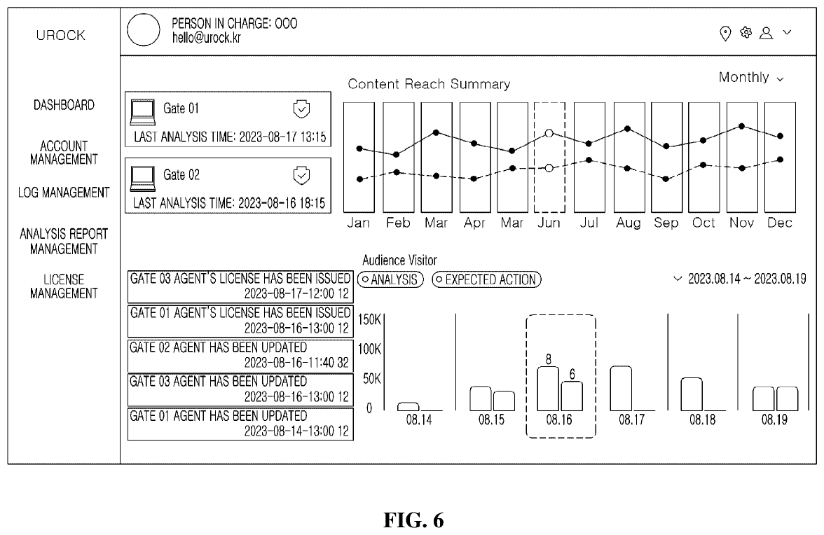

FIGS. 5 and 6 show screens by which mobile device analysis content and statistics can be remotely checked through a web manager according to an embodiment of the present disclosure.

FIG. 5A shows a screen by which an agent checks a list after analysis. Completion of extraction of an original file and a thumbnail file of a file in which an abnormality has been detected, file deletion, and result report generation can be checked through a detailed view function for the analyzed case.

FIG. 5B shows a screen by which completion of extraction of an original file and a thumbnail file of a file in which an abnormality has been detected, file deletion, and result report generation can be checked.

Referring to FIG. 6, the detection server 200 may check at least one of a diagnosis status, recent work activity, and license status of the mobile device through the dashboard of the web manager. In addition, the detection server 200 may manage accounts for granting administrator and user authority, and manage at least one of analysis content and analysis result reports. In case of multiple agents, at least one of policy settings, analysis settings, gate settings, and report template settings may be customized in the web manager according to the operating status of each agent.

Although the present disclosure has been described above with reference to preferred embodiments, it will be understood by those skilled in the art that various modifications and changes may be made to the present disclosure without departing from the idea and scope of the present disclosure as set forth in the following claims.

What is claimed is:

1. A method of detecting mobile security file leakage, comprising:
receiving, by a detection server, an operating system type from a mobile device;
connecting, by the detection server, to the mobile device depending on an operating system to load a media file system;
checking an analysis setting time by the detection server connected to the mobile device;
analyzing, by the detection server, the media file system to detect presence or absence of an abnormality;
generating, by the detection server, an analysis result based on presence or absence of an abnormality;
checking whether there is an error in the analysis result and extracting an original file and a thumbnail file if there is no error by the detection server;
deleting, by the detection server, a file from which an abnormality is detected based on the analysis result; and
generating and storing a result report on the analysis result by the detection server,
wherein the operating system type is at least one of a first operating system and a second operating system, and the analyzing, by the detection server, the media file system to detect presence or absence of an abnormality comprises:
when the operating system type received from the mobile device is the first operating system, performing, by the first operating system, general analysis to analyze directory files, application-specific directories, and deleted data in the media file system;
performing, by the first operating system, detailed analysis to analyze a file system and logs in the media file system;
performing, by the first operating system, hidden analysis to analyze DB files, DB logs, and a security folder in the media file system; and
detecting, by the first operating system, presence or absence of an abnormality through analysis content of at least one of the general analysis, detailed analysis, and hidden analysis.

2. The method of claim 1, wherein the detection server uses, as criteria for determining presence or absence of an abnormality, a case in which use of a camera is detected during the analysis setting time in the media file system, a case in which creation and modification of a directory and a file are detected during the analysis setting time, a case in which a usage pattern of the mobile device is analyzed to detect media file creation and action different from the pattern, and a case in which an abnormality is determined by extracting necessary data from media-related DB data.

3. The method of claim 1, wherein the analyzing, by the detection server, the media file system to detect presence or absence of is an abnormality comprises:
performing, by the second operating system, general analysis to analyze directory files, application-specific directories, and deleted data in the media file system when the operating system type received from the mobile device is the second operating system;
performing, by the second operating system, detailed analysis to analyze media resource files in the media file system; and
detecting, by the second operating system, presence or absence of an abnormality through analysis content of at least one of the general analysis and the detailed analysis.

4. A mobile security file leakage detection system comprising:
a mobile device configured to transmits an operating system type to a detection server and connected to the detection server depending on the operating system type; and
the detection server configured to receive the operating system type from the mobile device, connect to the mobile device depending on an operating system to load a media file system, check an analysis setting time, analyze the media file system to detect presence or absence of an abnormality, generate an analysis result based on presence or absence of an abnormality, check whether there is an error in the analysis result, extract an original image and a thumbnail image if there is no error, delete a file from which an abnormality is detected based on the analysis result, and generate and store a result report on the analysis result,
wherein, when the detection server analyzes the media file system to detect presence or absence of an abnormality, if the operating system type received from the mobile device is a first operating system, the first operating system performs general analysis to analyze directory files, application-specific directories, and deleted data in the media file system, performs detailed analysis to analyze a file system and logs in the media file system, performs hidden analysis to analyze DB files, DB logs, and a security folder in the media file system, and detects presence or absence of an abnormality through analysis content of at least one of the general analysis, detailed analysis, and hidden analysis.

5. The mobile security file leakage detection system of claim 4, wherein the detection server uses, as criteria for determining presence or absence of an abnormality, a case in which use of a camera is detected during the analysis setting time in the media file system, a case in which creation and modification of a directory and a file are detected during the analysis setting time, a case in which a usage pattern of the mobile device is analyzed to detect media file creation and action different from the pattern, and a case in which an abnormality is determined by extracting necessary data from media-related DB data.
